(19) United States
(12) Patent Application Publication
(10) Pub. No.: US 2014/0069089 A1
(43) Pub. Date: Mar. 13, 2014

(54) FLUID COUPLING

(71) Applicants: John C. Schultz, Saline, MI (US); Victor M. Roses, Ann Arbor, MI (US); Daryl A. Wilton, Macomb, MI (US)

(72) Inventors: John C. Schultz, Saline, MI (US); Victor M. Roses, Ann Arbor, MI (US); Daryl A. Wilton, Macomb, MI (US)

(73) Assignee: GM Global Technology Operations LLC, Detroit, MI (US)

(21) Appl. No.: 13/610,931

(22) Filed: Sep. 12, 2012

(51) Int. Cl. F16D 33/20

(52) U.S. Cl. 60/338; 60/330

(57) ABSTRACT

A fluid coupling is provided having a housing, an input member, a pump assembly, and a turbine assembly. The pump assembly includes a pump portion disposed opposite a turbine portion of the turbine assembly. The turbine assembly further includes a damper assembly having a plurality of springs disposed radially between the turbine portion and a transmission input shaft.

### TECHNICAL FIELD

The present disclosure relates to hydrodynamic fluid couplings, and more particularly to compact fluid couplings for use in combination with multispeed transmissions.

### BACKGROUND

The statements in this section merely provide background information related to the present disclosure and may or may not constitute prior art.

Fluid couplings are used to transfer torque from a prime mover, typically an internal combustion engine, to a transmission. Engines have become more powerful relative to their size with more torsionally active turbocharged three and four cylinder engines replacing smoother running six cylinder engines. At the same time, transmissions have added gear ratios in order to improve drivability and fuel economy. In the case of automatic transmissions having eight or more speed ratios, an additional gear set has increased the axial length of the transmission gearbox. This reduces the space available for the torque transfer device such as a torque convertor or fluid coupling. In the advancement to a more powerful and fuel efficient engine, natural damping characteristics of the engine are being lost in the name of efficiency, resulting in the passing along more of the unwanted vibrations to the transmission. Thus, there is a need for a new and improved fluid coupling having high torque capacity, shorter axial length for packaging, and improved damping characteristics.

### SUMMARY

A fluid coupling for transferring torque from an engine to a transmission is provided, the fluid coupling having a housing, an input member, a pump assembly, and a turbine assembly. The input member is fixedly connected for common rotation with a flexplate of the engine. The pump assembly is connected for common rotation with the input member. The pump assembly includes a pump member and a plurality of pump blades. The pump member is rotatably supported by the housing and includes a pump portion in which is disposed the plurality of pump blades. The turbine assembly includes a turbine member, a plurality of turbine blades, a damper assembly, and an annular hub member. The hub member is fixed for common rotation with the input shaft of the transmission. The turbine member is rotatably supported by the hub member. The turbine member includes a turbine portion in which is disposed the plurality of turbine blades. The pump portion and the turbine portion are disposed at the outer periphery of the pump assembly and turbine assembly, respectively, and the plurality of springs are disposed radially between the turbine portion and the hub member.

In another embodiment of the present invention, the input member has a plate portion and an edge portion, and the pump member has a plate portion and an edge portion, and wherein the edge portion of the input member is disposed on the outer periphery of the plate portion, the edge portion of the pump member is disposed on the outer periphery of the plate portion, the edge portion of the input member is extended axially rearward from the plate portion, the edge portion of the pump member is extended axially forward from the plate portion.

In yet another embodiment of the present invention, the pump portion of the pump member includes a channel having an outer diameter side, an inner diameter side and a base, and wherein the sides have an arcuate cross-sectional shape and the base is planar.

In yet another embodiment of the present invention, the turbine portion of the turbine member includes a channel having an outer diameter side, an inner diameter side and a base, and wherein the sides have an arcuate cross-sectional shape and the base has a planar shape.

In yet another embodiment of the present invention, the pump portion of the pump member includes a channel having an outer diameter side, an inner diameter side and a base, and wherein the sides and the base each have an arcuate cross-sectional shape.

In yet another embodiment of the present invention, the turbine portion of the turbine member includes a channel having an outer diameter side, an inner diameter side and a base, and wherein the sides and the base each have an arcuate cross-sectional shape.

In yet another embodiment of the present invention, the plurality of blades of each of the pump and turbine assemblies are flat and disposed such that each of the plurality of blades and the base of the channel forms a right angle.

In yet another embodiment of the present invention, the plurality of blades of each of the pump and the turbine assemblies have a blade base that is flat and a blade edge that is cantered.

In yet another embodiment of the present invention, each of the plurality of blades of the pump and the turbine assemblies are disposed normal to the inner diameter side of the channels of the pump and turbine portions, respectively.

In yet another embodiment of the present invention, the damper assembly of the turbine assembly is disposed radially inward from the turbine portion of the turbine member.

In yet another embodiment of the present invention, the damper assembly of the turbine assembly includes a damper member and a plurality of springs, wherein the damper member is rotatably connected to the hub member, each of the plurality of springs has a first and second ends, and each of the first ends are supported by the damper member and each of the second ends are supported by the turbine member.

In yet another embodiment of the present invention, the turbine assembly further includes a second damper assembly disposed radially outward from the turbine portion of the turbine member.

In yet another embodiment of the present invention, the turbine assembly further includes a drive member, the damper assembly includes a first plurality of counterweights and a counterweight support member, each of the first plurality of counterweights are rotatably supported by the counterweight support member, the counterweight support member is rotatably connected for common rotation with the drive member.

In yet another embodiment of the present invention, the plurality of counterweights is disposed radially outward of the turbine portion of the turbine member.

In yet another embodiment of the present invention, the damper assembly further includes a second plurality of counterweights rotatably supported by the counterweight support member.

In yet another embodiment of the present invention, the pump assembly is disposed between the turbine assembly and the flywheel of the engine.

In yet another embodiment of the present invention, the plurality of turbine blades include about 73 blades, the plurality of pump blades include about 71 blades, and the diameter of the pump assembly is about 280 mm.

In yet another embodiment of the present invention, the plurality of turbine blades include about 53 blades, the plurality of pump blades include about 51 blades, and the diameter of the pump assembly is about 230 mm.

In yet another embodiment of the present invention, the plurality of turbine blades include about 83 blades, the plurality of pump blades include about 81 blades, and the diameter of the pump assembly is about 320 mm.

Further features, aspects and advantages of the present invention will become apparent by reference to the following description and appended drawings wherein like reference numbers refer to the same component, element or feature.

### BRIEF DESCRIPTION OF THE DRAWINGS

The drawings described herein are for illustration purposes only and are not intended to limit the scope of the present disclosure in any way.

FIG. 1 is a cross section of an exemplary fluid coupling according to an embodiment of the present invention;

FIG. 1A is a perspective view of a cut-away of an arrangement of blades in a pump assembly according to an embodiment of the present invention;

FIG. 1B is a cross-sectional view of a pump blade according to an embodiment of the present invention; and

FIG. 2 is a cross-sectional view of another exemplary fluid coupling according to an embodiment of the present invention;

FIG. 3, is a cross-sectional view of yet another exemplary fluid coupling according to an embodiment of the present invention;

FIG. 4 is a cross-sectional view of yet another exemplary fluid coupling according to an embodiment of the present invention; and

FIG. 5 is a graph depicting fluid coupling performance according to an embodiment of the present invention.

### DESCRIPTION

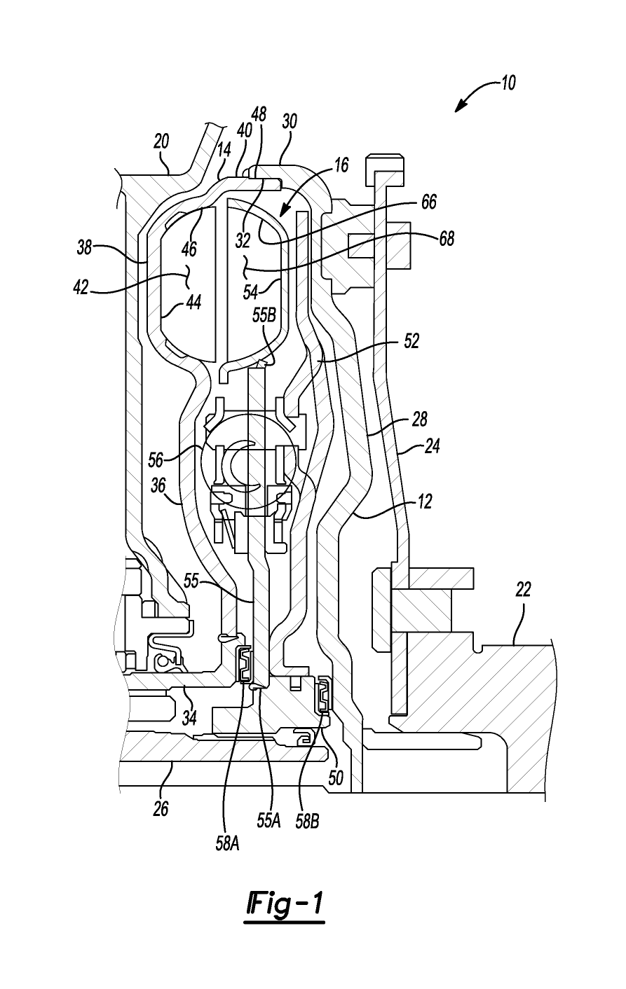

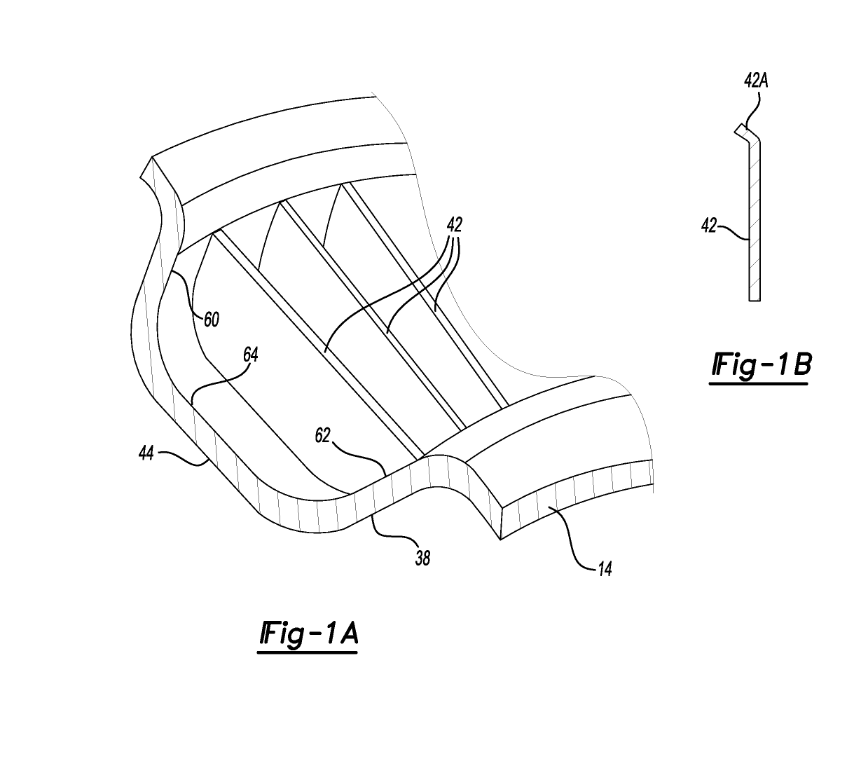

Referring to the drawings, wherein like reference numbers refer to like components, in FIG. 1 is a cross section of a fluid coupling assembly 10 illustrated in accordance with an example of the present invention. The fluid coupling assembly shown in FIG. 1 is disposed between an engine (not shown) and a transmission (not shown) such that the fluid coupling assembly 10 receives the torque output of the engine and transfers the torque output to the transmission. The fluid coupling assembly 10 includes an input member 12, a pump member 14, a turbine member 16, and a housing 20.

The input member 12 of the fluid coupling assembly 10 is solidly connected to an engine crankshaft 22 via a flexplate 24. The input member 12 has a plate portion 28 and an edge portion 30 that extends axially rearward (the opposite direction from the flexplate 24) from the plate portion 28.

The pump member 14 includes a hub 34, a plate portion 36, a pump portion 38, an edge portion 40, and a plurality of pump blades 42. The pump member 14 is rotatably supported by the housing 20 by way of the hub 34. The plate portion 36 extends radially outward from the hub 34. The plate portion 36 forms into the pump portion 38 that forms a channel 44 in which is disposed the plurality of pump blades 42. An open face 46 of the channel 44 is forward facing (faces the direction of the flexplate 24). The edge portion 40 of the pump member 14 extends from the outer circumference of the pump portion 38 towards the flexplate 24. The pump member 14 is welded to the input member 12 to provide for common rotation between the pump member 14 and the input member 12. However, other means for connecting the pump member 14 and the input member 12 for common rotation may be employed without departing from the scope of the invention.

The turbine assembly 16 includes a hub 50, a damper member 52, a turbine portion 54, a damper support member 55 and at least one spring 56. The damper member 52 is fixedly connected for common rotation with the hub 50 which in turn is rotatably connected via a spline interface with the transmission input shaft 26. The support member 55 is a relatively flat disk having an inner and outer periphery 55A, 55B. The inner periphery 55A is rotatably supported by the hub 50 while the outer periphery is fixed to the turbine portion 54. The turbine portion 54 takes the shape of an annular channel 66 in which is disposed the plurality of pump blades 68. An open face 70 of the channel 66 is rear facing (faces the direction opposite the flexplate 24) and is axially aligned with the open face 46 of the channel 44 of the pump member 14. The spring 56 is supported on one end by the damper support member 55 and on the other end by the damper member 52 thus preventing the transmission of selective engine vibrations through the turbine assembly 16. The spring 56 is further disposed radially inward from the turbine portion 54.

A first of two thrust bearings 58A is placed between the hub 34 of the pump member 14 and the damper member 55 while a second thrust bearing 58B is disposed between the hub 50 of the turbine assembly 16 and the input member 12.

Referring now to FIG. 1A with continuing reference to FIG. 1, the pump portion 38 of the pump member 14 is illustrated and will now be further described. The channel 44 of the pump portion 38 includes an outer diameter side 60, an inner diameter side 62, and a channel base 64. The sides 60, 62 are shaped having a radius while the base 64 of the channel 44 is flat with curvature only near the connection of the base 64 to the sides 60, 62, however, full torus curvature of various optimized shapes can be used without departing from the scope of this invention. The plurality of pump blades 42 are flat and disposed in the channel 44 extend radially from the inner diameter side 62 to the outer diameter side 64 so that the orientation of the plurality of blades 42 are normal to a circle defined by the inner diameter side 62. Furthermore, the plurality of blades 42 are also oriented perpendicular to the direction of rotation of the pump member 14. However, other blade orientations or shapes may be considered without departing from the scope of the invention. For example, the plurality of blades 42 may be predominantly flat while having a cantered blade edge 42A as shown in FIG. 1B. The orientation and shape of the plurality of blades 68 of the turbine member 16 may mimic the orientation and shape of the plurality of blades 42 of the pump member 14. The orientation and shape of the plurality of blades 42 of the pump member 14 and the disposition of the damper portion 52 of the turbine member 16 allow for the plurality of blades 42 to number between about 71 and 73 blades for a pump member 14 having a diameter of approximately 280 mm and a torque input capacity of approximately 400 Nm. Larger or smaller diameter pump members 14 may have more or less blades, respectively. For example, a 320 mm diameter pump member 14 may have from about 81 to 83 blades for a higher torque input capacity. Also, a 230 mm diameter pump member 14 may have from about 51 to 53 blades for a lower torque input capacity.

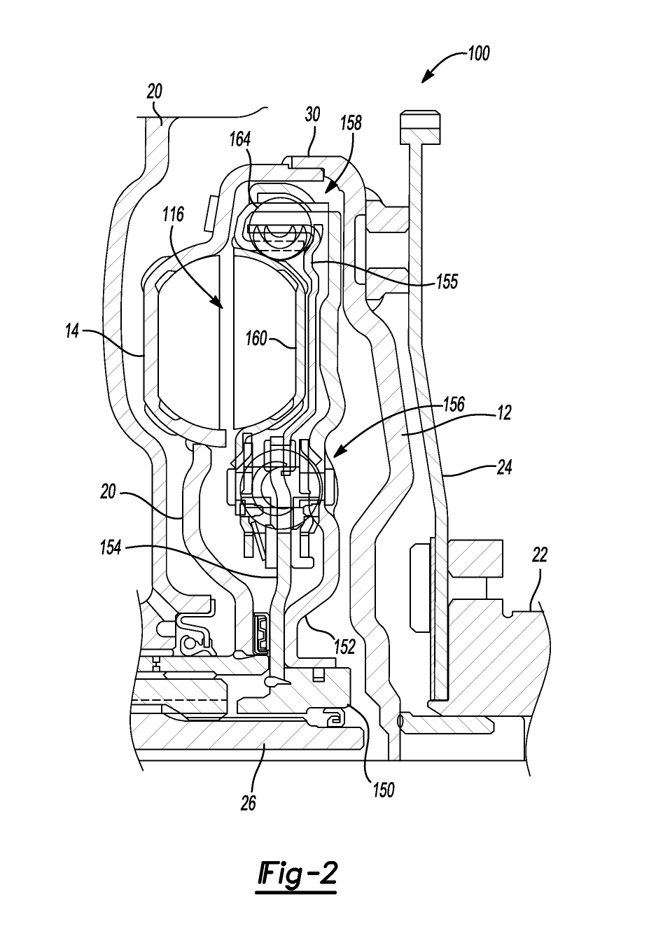

Referring now to FIG. 2, another example of the invention is illustrated in a cross-section of a fluid coupling 100. In this example, many of the reference numbers of fluid coupling assembly 10 shown in FIG. 1 are carried over on the components that remain the similar to those of fluid coupling assembly 100 in FIG. 2. The fluid coupling assembly 100 includes an input member 12, a pump member 14, a turbine assembly 116, an output member 18, and a housing 20. The turbine assembly 116 includes a hub 150, an output member 152, a first and second support members 154, 155 a first and second damper assemblies 156, 158, and a turbine portion 160. The output member 152 is fixedly connected for common rotation with the hub 150 which in turn is rotatably connected via a spline interface with the transmission input shaft 26. The first support member 154 is rotatably supported by the hub 150 on the inner periphery. The outer periphery of the first support member 154 is fixedly connected to the inner periphery of the second support member 155. The first damper assembly 156 includes a first spring 162. The first spring 162 is supported on one end by the first support member 154 and on the other end by the turbine portion 160 thus preventing the transmission of selective engine vibrations through the turbine assembly 116. The first damper assembly 156 is disposed radially inward from and generally on the same plane as the turbine portion 160. The second damper assembly 158 includes a second spring 164. The second spring 164 is supported on one end by the second support member 155 and on the other end by the turbine portion 160 thus preventing the transmission of selective engine vibrations through the turbine assembly 116. The spring 164 of the second damper assembly 158 may also have different diameter and spring constant characteristics than those of the first spring 156. The second damper assembly 158 is disposed such that the spring 164 is placed radially outward from the turbine portion 160 of the turbine assembly 116.

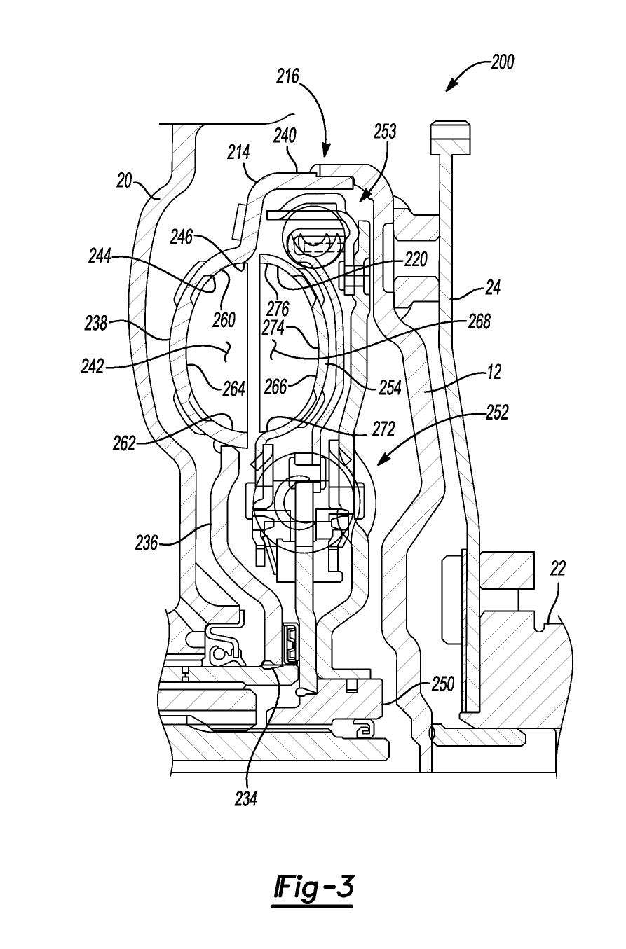

Referring now to FIG. 3, another example of the invention is illustrated in a cross-section of a fluid coupling 200. In this example, many of the reference numbers of fluid coupling assembly 100 shown in FIG. 2 are carried over on the components that remain the similar to those of fluid coupling assembly 200 in FIG. 3. The fluid coupling assembly 200 includes an input member 12, a pump member 214, a turbine assembly 216, and a housing 20. The pump member 214 includes a hub 234, a disk portion 236, a pump portion 238, an edge portion 240, and a plurality of pump blades 242. The pump member 214 is rotatably supported by the housing 20 by way of the hub 234. The disk portion 236 extends radially outward from the hub 234. The disk portion 236 connects to the pump portion 238 that forms a channel 244 in which is disposed the plurality of pump blades 242. An open face 246 of the channel 244 is forward facing (faces the direction of the flexplate 24). The channel 244 of the pump portion 238 includes an outer diameter side 260, an inner diameter side 262, and a channel base 264. The sides 260, 262 are shaped having a radius while the base 264 of the channel also has a rounded shape that blends into the sides 260, 262.

The turbine assembly 216 includes a hub 250, a first and a second damper assemblies 252, 253, and a turbine portion 254. The hub portion 250 is rotatably connected via a spline interface with the output shaft 226. The turbine portion 254 is defined in much the same manner as the pump portion 238 of the pump member 214. The turbine portion 254 forms a channel 266 in which is disposed the plurality of pump blades 268. The channel 266 of the turbine portion 254 includes an outer diameter side 270, an inner diameter side 272, and a channel base 274. The sides 270, 272 are shaped having a radius while the base 274 of the channel also has a round shape that blends into the sides 270, 272. An open face 276 of the channel 266 is rear facing (faces the direction opposite the flexplate 24) and is axially aligned with the open face 246 of the channel 244 of the pump member 214. The combination of the pump portion 238 and the turbine portion 254 forms a cross section that has a generally oval shape.

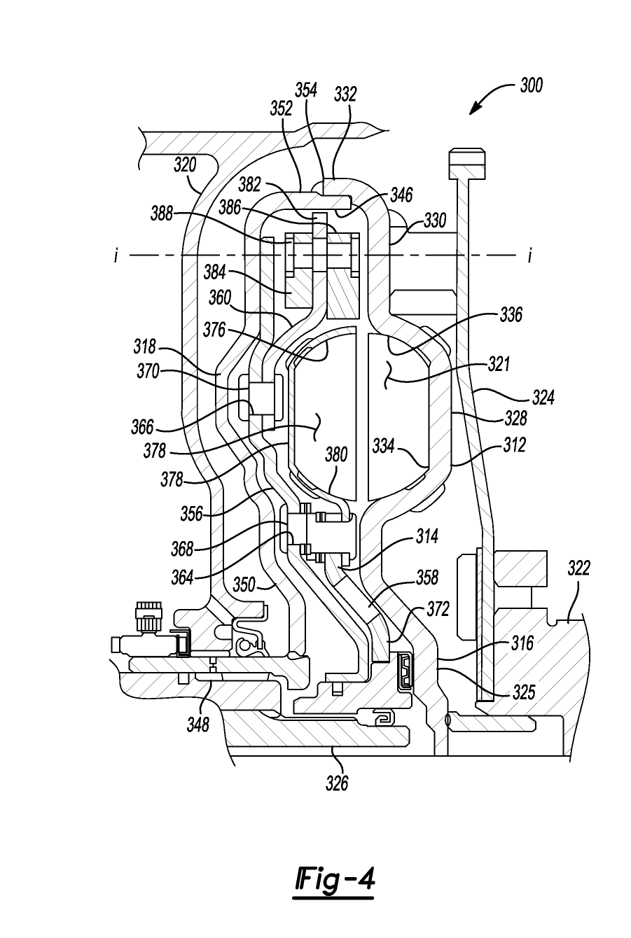

Referring now to FIG. 4, another example of the invention is illustrated in a cross-section of a fluid coupling 300. The fluid coupling assembly 300 includes a pump assembly 312, a turbine assembly 314, and a housing 320.

The pump assembly 312 includes a pump input member 316 bolted to a flywheel 324 which is in turn bolted to an engine crankshaft 322. Likewise, the turbine assembly 314 of the fluid coupling 300 is connected for common rotation to a transmission input shaft 326. The pump assembly 312 further includes a pump cover member 318, and a plurality of pump blades 321. The pump input member 316 includes a central disk portion 325, a pump portion 328, an outer disk portion 330, and an edge portion 332. The plurality of pump blades 321 is disposed in the pump portion 328. The pump portion 328 forms a channel 334 having an open face 336. The open face 336 of the channel 334 is rearward facing (faces opposite the direction of the flywheel 324). The edge portion 332 of the pump input member 316 extends axially from the outer periphery of the outer disk portion 330 away from the flywheel 324.

The pump cover member 318 includes a hub 348, a disk portion 350, and an edge portion 352. The hub portion of the pump cover member 318 is rotatably supported by the housing 320. The disk portion 350 extends between the hub 348 and the edge portion 352 and generally follows the contours of the turbine assembly 314. The edge portion 352 of the pump cover member 318 extends from the outer periphery of the disk portion 350 towards the flywheel 324 and is welded to the edge portion 332 of the pump input member 316. The welds between the edge portion 332 of the pump input member 316 and the edge portion 352 of the pump cover member provide for common rotation between the pump input member 316 and pump support member 318 at engine speed.

The turbine assembly 314 includes a drive member 356, a turbine member 358, a plurality of springs (not shown in FIG. 4, however, shown as 56 in FIG. 1), and a pendulum damper assembly 360. Each of the plurality of springs 56 is disposed in series with the pendulum damper assembly 360 between the drive member 356 and the turbine member 358. The drive member 356 includes a hub portion 362 and a first and second attachment bores 364, 366. The first attachment bore 364 receives a rivet fastener 368 that supports the turbine member 358. The second attachment bore 366 is disposed radially outward from the first attachment bore 364 and receives a rivet fastener 370 that supports the damper assembly 360.

The turbine member 358 includes an inner disk portion 372 and a turbine portion 374. The inner disk portion 372 is connected to the drive member 356 by the fastener 368 and extends radially inward. The turbine portion 374 forms a channel 376 in which is disposed the plurality of pump blades 378. An open face 380 of the channel 376 is forward facing (faces the flywheel 324) and is axially aligned with the open face 336 of the channel 334 of the pump member 312.

The pendulum damper assembly 360 includes a counterweight support member 382 and a first and second counterweights 384, 386. The counterweight support member 382 is connected to the drive member 356 by the rivet fastener 370 and extends radially outward. The first and second counterweights 384, 386 are rotatably supported by a fastener 388 which passes through the counterweights 384, 386 and the drive member 356 so that the counterweights 384, 386 are disposed radially outward and generally on the same axial plane as the turbine portion 374. The counterweights 384, 386 are further disposed on opposite axial surfaces of the counterweight support member 382 and rotatable about an axis i defined by the fastener 388. The counterweights 384, 386 can vary in weight depending upon the application of the fluid coupling 300.

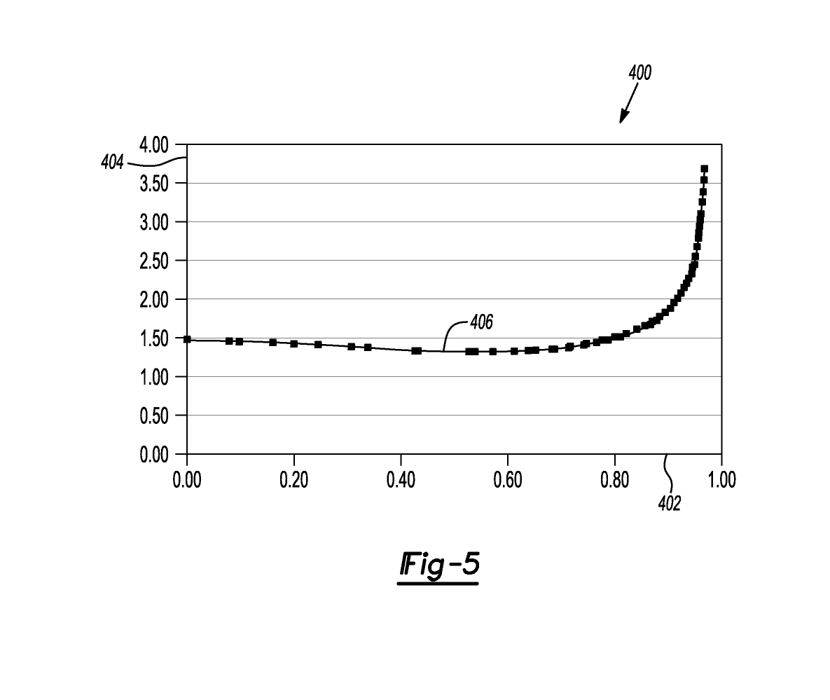

Referring now to FIG. 5, a graph 400 depicting the performance of a fluid coupling according to an example of the present invention is illustrated and will now be described. A horizontal or X axis 402 represents the speed ratio between the fluid coupling pump and turbine members (turbine speed/pump speed). A vertical or Y axis 404 represents the K-factor/100 which is the input speed divided by the square root of the input torque. The data curves 406 represent fluid coupling performance at each of 200 Nm, 300 Nm, and 400 Nm torque input.

The description of the invention is merely exemplary in nature and variations that do not depart from the general essence of the invention are intended to be within the scope of the invention. Such variations are not to be regarded as a departure from the spirit and scope of the invention.

We claim the following:

1. A fluid coupling for transferring torque from an engine to a transmission, the fluid coupling comprising:
a housing;
an input member fixedly connected for common rotation with a flywheel of the engine;
a pump assembly connected for common rotation with the input member, the pump assembly including a pump member and a plurality of pump blades, and wherein the pump member is rotatably supported by the housing and includes a pump portion in which is disposed the plurality of pump blades, and
a turbine assembly including a turbine member, a plurality of turbine blades, a damper assembly, and an annular hub member, and wherein the hub member is fixed for common rotation with the input shaft of the transmission, the turbine member is rotatably supported by the hub member, and the turbine member includes a turbine portion in which is disposed the plurality of turbine blades; and
wherein the pump portion and the turbine portion are disposed at the outer periphery of the pump assembly and turbine assembly, respectively, and the plurality of springs are disposed radially between the turbine portion and the hub member.

2. The fluid coupling of claim 1 wherein the input member has a plate portion and an edge portion, and the pump member has a plate portion and an edge portion, and wherein the edge portion of the input member is disposed on the outer periphery of the plate portion, the edge portion of the pump member is disposed on the outer periphery of the plate portion, the edge portion of the input member is extended axially rearward from the plate portion, the edge portion of the pump member is extended axially forward from the plate portion.

3. The fluid coupling of claim 1 wherein the pump portion of the pump member includes a channel having an outer diameter side, an inner diameter side and a base, and wherein the sides have an arcuate cross-sectional shape and the base is planar.

4. The fluid coupling of claim 3 wherein the turbine portion of the turbine member includes a channel having an outer diameter side, an inner diameter side and a base, and wherein the sides have an arcuate cross-sectional shape and the base has a planar shape.

5. The fluid coupling of claim 1 wherein the pump portion of the pump member includes a channel having an outer diameter side, an inner diameter side and a base, and wherein the sides and the base each have an arcuate cross-sectional shape.

6. The fluid coupling of claim 1 wherein the turbine portion of the turbine member includes a channel having an outer diameter side, an inner diameter side and a base, and wherein the sides and the base each have an arcuate cross-sectional shape.

7. The fluid coupling of claim 1 wherein the plurality of blades of each of the pump and turbine assemblies are flat and disposed such that each of the plurality of blades and the base of the channel forms a right angle.

8. The fluid coupling of claim 1 wherein the plurality of blades of each of the pump and the turbine assemblies have a blade base that is flat and a blade edge that is cantered.

9. The fluid coupling of claim 1 wherein each of the plurality of blades of the pump and the turbine assemblies are disposed normal to the inner diameter side of the channels of the pump and turbine portions, respectively.

10. The fluid coupling of claim 1 wherein the damper assembly of the turbine assembly is disposed radially inward from the turbine portion of the turbine member.

11. The fluid coupling of claim 10 wherein the damper assembly of the turbine assembly includes a damper member and a plurality of springs, wherein the damper member is rotatably connected to the hub member, each of the plurality of springs has a first and second ends, and each of the first ends are supported by the damper member and each of the second ends are supported by the turbine member.

12. The fluid coupling of claim 10 wherein the turbine assembly further includes a second damper assembly disposed radially outward from the turbine portion of the turbine member.

13. The fluid coupling of claim 1 wherein the pump member of the pump assembly and the input member form a pump input member.

14. The fluid coupling of claim 13 wherein the turbine assembly further includes a drive member, the damper assembly includes a first plurality of counterweights and a counterweight support member, each of the first plurality of counterweights are rotatably supported by the counterweight support member, the counterweight support member is rotatably connected for common rotation with the drive member.

15. The fluid coupling of claim 14 wherein the plurality of counterweights is disposed radially outward of the turbine portion of the turbine member.

16. The fluid coupling of claim 15 wherein the damper assembly further includes a second plurality of counterweights rotatably supported by the counterweight support member.

17. The fluid coupling of claim 16 wherein the pump assembly is disposed between the turbine assembly and the flywheel of the engine.

18. The fluid coupling of claim 17 wherein the plurality of turbine blades include about 73 blades, the plurality of pump blades include about 71 blades, and the diameter of the pump assembly is about 280 mm.

19. The fluid coupling of claim 17 wherein the plurality of turbine blades include about 53 blades, the plurality of pump blades include about 51 blades, and the diameter of the pump assembly is about 230 mm.

20. The fluid coupling of claim 17 wherein the plurality of turbine blades include about 83 blades, the plurality of pump blades include about 81 blades, and the diameter of the pump assembly is about 320 mm.

21. A fluid coupling for transferring torque from an engine to a transmission, the fluid coupling comprising:
a housing;
an input member fixedly connected for common rotation with a flywheel of the engine;
a pump assembly connected for common rotation with the input member, the pump assembly including a pump member and a plurality of pump blades, and wherein the pump member is rotatably supported by the housing and includes a pump portion in which is disposed the plurality of pump blades, and
a turbine assembly including a turbine member, a plurality of turbine blades, a damper assembly, and an annular hub member, and wherein the hub member is fixed for common rotation with the input shaft of the transmission, the turbine member is rotatably supported by the hub member, and the turbine member includes a turbine portion in which is disposed the plurality of turbine blades; and
wherein the pump portion and the turbine portion are disposed at the outer periphery of the pump assembly and turbine assembly, respectively, the plurality of springs are disposed radially between the turbine portion and the hub member, and the plurality of blades of each of the pump and turbine assemblies are flat and disposed such that each of the plurality of blades and the base of the channel forms a right angle.

22. The fluid coupling of claim 21 wherein the input member has a plate portion and an edge portion, and the pump member has a plate portion and an edge portion, and wherein the edge portion of the input member is disposed on the outer periphery of the plate portion, the edge portion of the pump member is disposed on the outer periphery of the plate portion, the edge portion of the input member is extended axially rearward from the plate portion, the edge portion of the pump member is extended axially forward from the plate portion.

23. The fluid coupling of claim 21 wherein the pump portion of the pump member includes a channel having an outer diameter side, an inner diameter side and a base, and wherein the sides have an arcuate cross-sectional shape and the base is planar.

24. The fluid coupling of claim 23 wherein the turbine portion of the turbine member includes a channel having an outer diameter side, an inner diameter side and a base, and wherein the sides have an arcuate cross-sectional shape and the base has a planar shape.

25. The fluid coupling of claim 21 wherein the pump portion of the pump member includes a channel having an outer diameter side, an inner diameter side and a base, and wherein the sides and the base each have an arcuate cross-sectional shape.

26. The fluid coupling of claim 21 wherein the turbine portion of the turbine member includes a channel having an outer diameter side, an inner diameter side and a base, and wherein the sides and the base each have an arcuate cross-sectional shape.

27. The fluid coupling of claim 21 wherein the plurality of blades of each of the pump and the turbine assemblies have a blade edge that is cantered.

28. The fluid coupling of claim 21 wherein each of the plurality of blades of the pump and the turbine assemblies are disposed normal to the inner diameter side of the channels of the pump and turbine portions, respectively.

29. The fluid coupling of claim 21 wherein the damper assembly of the turbine assembly is disposed radially inward from the turbine portion of the turbine member.

30. The fluid coupling of claim 29 wherein the damper assembly of the turbine assembly includes a damper member and a plurality of springs, wherein the damper member is rotatably connected to the hub member, each of the plurality of springs has a first and second ends, and each of the first ends are supported by the damper member and each of the second ends are supported by the turbine member.

31. The fluid coupling of claim 29 wherein the turbine assembly further includes a second damper assembly disposed radially outward from the turbine portion of the turbine member.

32. The fluid coupling of claim 21 wherein the pump member of the pump assembly and the input member form a pump input member.

33. The fluid coupling of claim 32 wherein the turbine assembly further includes a drive member, the damper assembly includes a first plurality of counterweights and a counterweight support member, each of the first plurality of counterweights are rotatably supported by the counterweight support member, the counterweight support member is rotatably connected for common rotation with the drive member.

34. The fluid coupling of claim 33 wherein the plurality of counterweights is disposed radially outward of the turbine portion of the turbine member.

35. The fluid coupling of claim 34 wherein the damper assembly further includes a second plurality of counterweights rotatably supported by the counterweight support member.

36. The fluid coupling of claim 35 wherein the pump assembly is disposed between the turbine assembly and the flywheel of the engine.

37. The fluid coupling of claim 36 wherein the plurality of turbine blades include about 73 blades, the plurality of pump blades include about 71 blades, and the diameter of the pump assembly is about 280 mm.

38. The fluid coupling of claim 36 wherein the plurality of turbine blades include about 53 blades, the plurality of pump blades include about 51 blades, and the diameter of the pump assembly is about 230 mm.

39. The fluid coupling of claim 36 wherein the plurality of turbine blades include about 83 blades, the plurality of pump blades include about 81 blades, and the diameter of the pump assembly is about 320 mm.

40. A fluid coupling for transferring torque from an engine to a transmission, the fluid coupling comprising:
a housing;
an input member fixedly connected for common rotation with a flywheel of the engine;
a pump assembly connected for common rotation with the input member, the pump assembly including a pump member and a plurality of pump blades, and wherein the pump member is rotatably supported by the housing and includes a pump portion in which is disposed the plurality of pump blades, the pump portion includes a channel having an outer diameter side, an inner diameter side and a base and the inner and outer diameter sides have an arcuate cross-sectional shape, and
a turbine assembly including a turbine member, a plurality of turbine blades, a damper assembly, and an annular hub member, and wherein the hub member is fixed for common rotation with the input shaft of the transmission, the turbine member is rotatably supported by the hub member, and the turbine member includes a turbine portion in which is disposed the plurality of turbine blades; and
wherein the pump portion and the turbine portion are disposed at the outer periphery of the pump assembly and turbine assembly, respectively, and the plurality of springs are disposed radially between the turbine portion and the hub member.

41. The fluid coupling of claim 40 wherein the input member has a plate portion and an edge portion, and the pump member has a plate portion and an edge portion, and wherein the edge portion of the input member is disposed on the outer periphery of the plate portion, the edge portion of the pump member is disposed on the outer periphery of the plate portion, the edge portion of the input member is extended axially rearward from the plate portion, the edge portion of the pump member is extended axially forward from the plate portion.

42. The fluid coupling of claim 40 wherein the base of the pump portion of the pump member is planar.

43. The fluid coupling of claim 42 wherein the turbine portion of the turbine member includes a channel having an outer diameter side, an inner diameter side and a base, and wherein the sides have an arcuate cross-sectional shape and the base has a planar shape.

44. The fluid coupling of claim 40 wherein the base of the pump portion of the pump member has an arcuate cross-sectional shape.

45. The fluid coupling of claim 40 wherein the turbine portion of the turbine member includes a channel having an outer diameter side, an inner diameter side and a base, and wherein the sides and the base each have an arcuate cross-sectional shape.

46. The fluid coupling of claim 40 wherein the plurality of blades of each of the pump and turbine assemblies are flat and disposed such that each of the plurality of blades and the base of the channel forms a right angle.

47. The fluid coupling of claim 40 wherein the plurality of blades of each of the pump and the turbine assemblies have a blade base that is flat and a blade edge that is cantered.

48. The fluid coupling of claim 40 wherein each of the plurality of blades of the pump and the turbine assemblies are disposed normal to the inner diameter side of the channels of the pump and turbine portions, respectively.

49. The fluid coupling of claim 40 wherein the damper assembly of the turbine assembly is disposed radially inward from the turbine portion of the turbine member.

50. The fluid coupling of claim 49 wherein the damper assembly of the turbine assembly includes a damper member and a plurality of springs, wherein the damper member is rotatably connected to the hub member, each of the plurality of springs has a first and second ends, and each of the first ends are supported by the damper member and each of the second ends are supported by the turbine member.

51. The fluid coupling of claim 49 wherein the turbine assembly further includes a second damper assembly disposed radially outward from the turbine portion of the turbine member.

52. The fluid coupling of claim 40 wherein the pump member of the pump assembly and the input member form a pump input member.

53. The fluid coupling of claim 52 wherein the turbine assembly further includes a drive member, the damper assembly includes a first plurality of counterweights and a counterweight support member, each of the first plurality of counterweights are rotatably supported by the counterweight support member, the counterweight support member is rotatably connected for common rotation with the drive member.

54. The fluid coupling of claim 53 wherein the plurality of counterweights is disposed radially outward of the turbine portion of the turbine member.

55. The fluid coupling of claim 54 wherein the damper assembly further includes a second plurality of counterweights rotatably supported by the counterweight support member.

56. The fluid coupling of claim 55 wherein the pump assembly is disposed between the turbine assembly and the flywheel of the engine.

57. The fluid coupling of claim 56 wherein the plurality of turbine blades include about 73 blades, the plurality of pump blades include about 71 blades, and the diameter of the pump assembly is about 280 mm.

58. The fluid coupling of claim 56 wherein the plurality of turbine blades include about 53 blades, the plurality of pump blades include about 51 blades, and the diameter of the pump assembly is about 230 mm.

59. The fluid coupling of claim 56 wherein the plurality of turbine blades include about 83 blades, the plurality of pump blades include about 81 blades, and the diameter of the pump assembly is about 320 mm.
